(19) United States
(12) Patent Application Publication
(10) Pub. No.: US 2022/0264845 A1
(43) Pub. Date: Aug. 25, 2022

(54) DEVICE FOR WATERING ANIMALS

(71) Applicant: PIPOLINO, Viileneuve-Loubet (FR)

(72) Inventor: Pascal LESCROART, Villeneuve-Loubet (FR)

(21) Appl. No.: 17/625,642

(22) PCT Filed: Jul. 3, 2020
(86) PCT No.: PCT/EP2020/068888

§ 371 Date: Jan. 7, 2022

(30) Foreign Application Priority Data
Jul. 8, 2019 (FR) FR1907624

(51) Int. Cl. A01K 7/02

(52) U.S. Cl. CPC A01K 7/027

(57) ABSTRACT

A watering device for animals includes a support, which includes a watering trough intended to receive a liquid, a system for cooling the liquid, wherein the system for cooling the liquid has a thermoelectric module powered with a current and having a first contact element and a second contact element, the first contact element for cooling the liquid.

### TECHNICAL FIELD

The invention relates to the field of watering devices for animals, in particular for cats.

### PRIOR ART

There are several devices that allow animals to hydrate.

It is known that cats need water that is cool enough to be able to hydrate. Indeed, the nature of the animal repels it from drinking lukewarm water. This reluctance then often leads to underhydration of the animal.

The evaporation of water by stirring in cat watering fountains allows for only a slight drop in its temperature, which is insufficient for the comfort of the animal. In addition, this mixing of the water produces a permanent humidification of the internal walls which, poorly ventilated, are conducive to the development of molds which alter the taste of the water and could turn out to be toxic.

Finally, the noise caused by stirring of water in fountains is detrimental to the well-being of cats. Yet, it is known that these need to hydrate calmly and in anti-stress conditions, which are beneficial to their health.

In the document US 2007/227456 A1, a device for animals is disclosed, comprising a tank arranged vertically, which may contain food or a thirst-quenching liquid. However, this device does not allow easy access for the animal, in particular because of its configuration extending in a vertical direction. For example, an animal with a small neck will have difficulty feeding itself through this device.

In the document WO2017185053A1, a cooling and water supply system for pets is described. This device also does not allow for an easy access to the refrigerated water reserve because it provides for the liquid to be poured into a bowl. In addition, it also seems to reveal a heat pump that could disconcert the animal by generating vibrations.

Consequently, an object of the present invention is to provide a watering device that is easily accessible to animals, allowing maintaining water cool enough while allowing the animal to hydrate serenely.

The other objects, features and advantages of the present invention will become apparent upon examining the following description and the appended drawings. Of course, other advantages could be incorporated.

### SUMMARY

To achieve this objective, according to one embodiment, the present invention provides a drinking device for animals comprising a support, which comprises:
a watering tank intended to receive a liquid,
a liquid cooling system, characterised in that it comprises a liquid cooling system, comprises a thermoelectric module powered with a current and having a first contact element and a second contact element, the first contact element being configured to cool the liquid.

The present invention allows the animal to have sufficiently fresh water. Knowing that the nature of the animal makes it reluctant to drink lukewarm water, the present invention thus makes it possible to further prevent underhydration of the animal. Moreover, cooling of the water by the use of a thermoelectric module allows the animal to hydrate under favorable phonic conditions. Thus, the animal hydrates under anti-stress conditions, which are beneficial to its health.

### BRIEF DESCRIPTION OF THE FIGURES

The aims, objects, as well as the features and advantages of the invention will appear better from the detailed description of an embodiment thereof which is illustrated by the following appended drawings wherein:

FIG. 1A represents an external view of the device according to a first embodiment.

FIG. 1B shows a cross section of the device of FIG. 1A.

FIG. 2A represents an exterior view of the device according to a second embodiment.

FIG. 2B represents a top view of the device of FIG. 2A.

FIG. 2C shows a cross section of the device of FIG. 2A.

The drawings are given as examples and do not limit the invention. They consist of schematic principle representations intended to facilitate understanding of the invention and are not necessarily to the scale of practical applications.

### DETAILED DESCRIPTION

Before starting a detailed review of embodiments of the invention, optional features are listed hereinafter which could possibly be used in combination or alternatively:
According to one example, the first contact element is in thermal conduction with the watering trough so as to enable a heat exchange between the first contact element and the watering trough.
According to one example, the second contact element is in thermal conduction with a receiver element intended to receive calories.
According to one example, the second contact element has dissipation fins configured to dissipate heat towards the receiver element. Incidentally, a mechanical device (turbine, fan, pump, . . . ) will animate the fluid in contact with the fins to amplify the heat exchanges between the fins and this fluid.
According to one example, the support comprises a first portion carrying the watering trough and a second portion distinct from the first portion so that the thermal conduction resistance of the first portion is higher than the thermal conduction resistance of the second portion.
This allows maintaining the temperature of the liquid contained in the watering trough.
According to one example, the support comprises a support surface bordering the watering trough, said support having a lower face intended to bear on the ground so that the support surface is parallel to the lower face.
According to one example, the support surface is flush with an upper edge of the watering trough.
According to one example, the support surface has a depth P starting from the upper edge of the watering trough, said depth P being at least 4 cm.
According to one example, the support surface is intended to receive the legs of the animal, said support surface extending at least to the same height H as the upper edge of the watering trough.
The present invention enables the animal through the support surface to hydrate by having its legs at the same level as the liquid, by having its head in line with the neck, the throat stretched, the back straight. Thus, the animal hydrates in a physiological position that makes swallowing easier. Consequently, swallowing difficulties and pain due to a poor posture, which could lead to underhydration of the animal, are avoided.
According to one example, the support is partly hollow, defining an internal cavity of the support so that the receiver element is contained within the internal cavity of the support.
According to one example, the internal cavity of the support is located under the support surface.
According to one example, the internal cavity of the support has ventilation channels establishing a passage between the internal cavity of the support and the exterior of the support.
According to one example, the support comprises an additional trough, containing the receiver element in so as enable a heat exchange between the liquid contained in the watering trough and the receiver element contained within the additional trough.
According to one example, the first contact element and the second contact element of the thermoelectric module are respectively a first heat-conductive plate and a second heat-conductive plate.
According to an example, the first plate is immersed in the watering trough.
According to one example, the first heat-conductive plate has a length substantially equal to the length of the watering trough.
This allows maximising the heat exchanges between the liquid and the first plate. Thus, the thermal transfer of the calories contained in the liquid towards the additional trough occurs more quickly. Consequently, the liquid cools down more quickly.
According to one example, the watering trough is removable from the support.
This allows facilitating filling and cleaning of the watering trough.
According to one example, the watering trough is made of a material whose thermal conductivity is higher than 10 Watt per metre-Kelvin at 20° C.
According to one example, the cooling system comprises a thermostat configured to maintain the temperature of the liquid contained in the watering trough at a temperature between 5° C. and 15° C., preferably between 8° C. and 12° C.
This allows promoting the natural hydration of the animal.

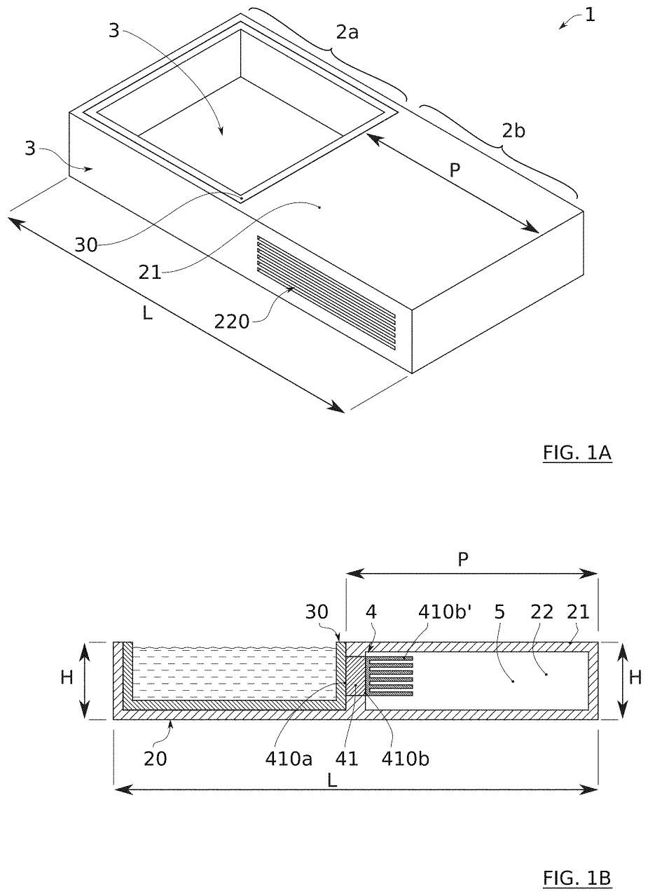

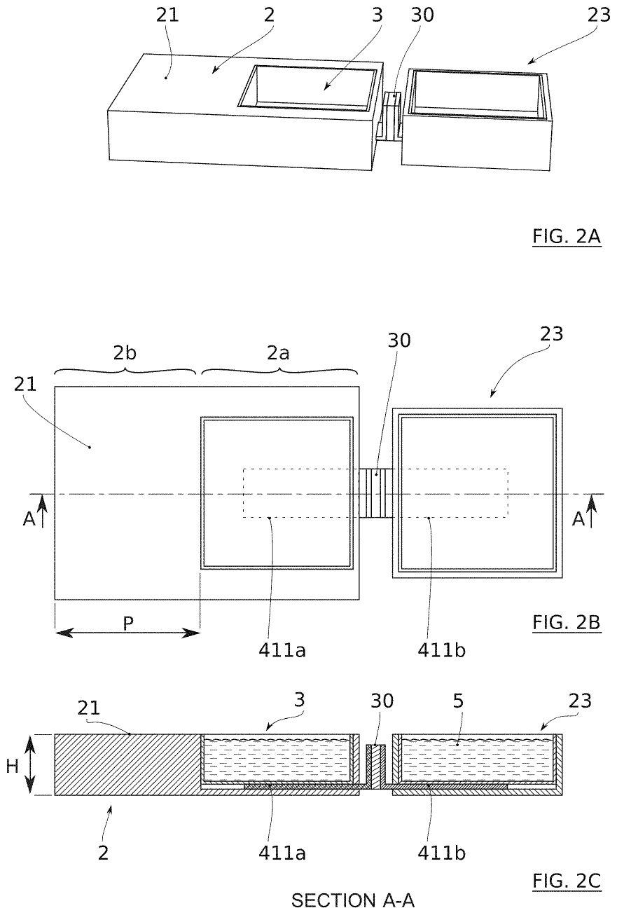

We will now describe the invention through FIGS. 1A to 2C.

A first embodiment is described by FIGS. 1A and 1B. We will first describe this mode.

FIGS. 1A and 2A represent a watering device 1 for animals, preferably for cats. This watering device 1 comprises a support 2.

The support is held stable on the ground. For this purpose, the support 2 advantageously has a lower face 20 as represented in FIG. 1B, intended to bear, preferably isostatically, on the ground. In addition, the dimensions of the support 2 are set so as to make it easy to access of animals such as cats.

The support 2 comprises a watering trough 3. The watering trough 3 may have at least one side wall, preferably four, and a bottom wall. The watering trough 3 has a lengthwise dimension. The watering trough 3 has an inner surface and an outer surface so that the outer surface of the watering trough 3 is in contact with the support 2. The watering trough 3 is intended to receive a liquid, preferably water. This aspect is separable from the cooling system feature.

The support 2 comprises a first portion 2a and a second portion 2b. Preferably, the first portion 2a carries the watering trough 3 and the second portion 2b is distinct from the first portion 2a.

More advantageously, the watering trough 3 is removable from the support 2. This allows facilitating filling of the watering trough 3 with said liquid. This also allows facilitating cleaning of the watering trough 3. Another advantage is that, in the event of breakage or failure of the watering trough 3, it is easy to replace it without having to change the entire watering device 1. Thus, this saves the mass of wastes generated by the failure of a portion of the watering device 1.

The watering device 1 comprises a system 4 for cooling said liquid as shown in FIG. 1B. As a non-limiting example, the cooling system 4 comprises a thermostat configured to maintain the temperature of the liquid contained in the watering trough 3 at a temperature comprised between 5° C. and 15° C., preferably between 8° C. and 12° C. This allows refreshing, and possibly maintaining the temperature of the liquid contained in the watering trough 3 at a temperature suited for the hydration of the animal. Thus, the animal has at its disposal conditions that favor its desire to drink. Indeed, it is known that lukewarm water repels animals, in particular cats. Thus, this prevents underhydration of the animal, which allows keeping the animal in good health conditions.

The liquid cooling system 4 comprises a thermoelectric module 41 powered with a current. The thermoelectric module 41 is of the “Peltier module” type. Advantageously, the thermoelectric module 41 is located within the support 2. The support 2 has a length L, so that the thermoelectric module 41 is located for example at half the length L of the support 2. The thermoelectric module 41 has a first contact element 410a and a second contact element 410b. The first contact element 410a is configured to cool the liquid. For this purpose, the first contact element 410a is in thermal conduction with the watering trough 3, preferably the first contact element 410a is in thermal conduction with the outer surface of the watering trough 3, still preferably with the outer surface of the side wall of the watering trough 3. Alternatively, the first contact element 410a is in thermal conduction with the outer surface of the bottom wall of the watering trough 3. Thus, a heat exchange between the first contact element 410a and the watering trough 3 is authorised. When the watering trough 3 contains the liquid, it is also a heat exchange between the liquid and the first contact element 410a which is authorised. According to a quite advantageous embodiment, the watering trough 3 is made of a material whose thermal conductivity is higher than 10 Watts per metre-Kelvin at 20° C. This allows facilitating the thermal transfer of the calories contained in the liquid towards the inner surface of the watering trough 3, then towards the outer surface of the watering trough 3 and then towards the first contact element 410a.

According to a preferred embodiment, the second contact element 410b is in thermal conduction with a receiver element 5 intended to receive calories. Optionally, the second contact element 410b is located opposite to the first contact element 410a, each located at the opposite ends of the thermoelectric module 41. The receiver element 5 is located outside the watering trough 3. As represented in FIG. 1B, the second contact element 410b advantageously has dissipation fins 410b′. The dissipation fins 410b are intended to dissipate the calories towards the receiver element 5. The dissipation fins 410b′ may have a length extending along the entirety of the internal cavity. This enables the transfer of calories from the liquid contained in the watering trough 3 towards the receiver element 5 located outside the watering trough 3, throughout the first contact element 410a and the second contact element 410b. Thus, the liquid of the watering trough 3 is cooled, and the receiver element 5 is warmed up. The animal could drink sufficiently cool water thereby avoiding underhydration. According to an alternative embodiment, the cooling system 4 is configured so as to cool the receiver element 5 and heat the liquid contained within the watering trough 3.

The first contact element 410a and the second contact element 410b are configured so as to maximise the heat-exchange surfaces between, respectively, the liquid contained in the watering trough 3 and the receiver element 5.

The first contact element 410a and the second contact element 410b are metallic elements. This allows promoting the heat transfer.

According to this preferred embodiment, the receiver element 5 is air.

As illustrated in FIG. 1B, according to the preferred embodiment, the support 2 is partly hollow. Indeed, the support 2, preferably the second portion 2b of the support 2, defines an internal cavity 22. Advantageously, the internal cavity 22 contains the receiver element 5. Preferably, the dissipation fins 410b′ are located in the internal cavity 22. Thus, the dissipation fins 410b′ evacuate the heat in the internal cavity 22 which also contains the receiver element 5 which will then receive the heat. Once the heat is collected by the receiver element 5, this heat is evacuated. For this purpose, the internal cavity 22 of the support 2 has ventilation channels 220. The ventilation channels 220 establish a passage between the internal cavity 22 of the support 2 and the outside of the support 2. This allows evacuating the heat, which has been captured by the receiver element 5. Thus, overheating of the support 2 is avoided and also the deterioration to the support 2 is avoided. Preferably, the support is made of plastic or wood.

In addition, the first portion 2a and the second portion 2b of the support 2 are optionally configured so that the thermal conduction resistance of the first portion 2a is higher than the thermal conduction resistance of the second portion 2b. This allows better maintaining the temperature of the liquid contained in the watering trough 3. Indeed, the provided freshness thus remains in the first portion 2a of the support 2 and does not dissipate through the support 2, in particular through the second portion 2b of the support 2.

According to a preferred embodiment of the invention and as represented in FIGS. 1A and 1B, the support 2, preferably the second portion 2b of the support 2, comprises a support surface 21 bordering the watering trough 3. The support surface 21 is disposed so as to be parallel to the lower face 20 of the support 2 and consequently be parallel to the ground on which the lower face 20 is bearing.

In addition, the watering trough 3 has an upper edge 30. By “upper edge”, it should be understood the edge 30 of the watering trough 3 advantageously extending to the height H of the support 2. Advantageously, the support surface 21 is flush with the upper edge 30 of the watering trough 3.

According to a preferred embodiment, the support surface 21 has a depth P starting from the upper edge 30 of the watering trough 3. Optionally, the depth P is at least 4 cm.

According to another preferred embodiment, the support surface 21 is intended to receive the legs of the animal, preferably at least the anterior legs of the animal. The support surface 21 extends to the same height H as the edge of the watering trough 3 as represented in FIG. 1B. This feature enables the animal through the support surface 21 to hydrate itself by having its legs at the same level as the liquid, with the head in line with the neck, the throat stretched and the back straight. Thus, the animal hydrates itself in a physiological position that facilitates swallowing thereof. Consequently, swallowing difficulties and pain due to a poor posture are avoided, which might lead to underhydration of the animal.

Thus, the preferred yet non-limiting combination of sufficiently cool water, watering conditions in a silent and anti-stress environment, and a physiological position for watering the animal allows the animal to be in good health conditions, or to avoid the deterioration of these health conditions.

Preferably, the support surface 21 borders the watering trough 3 in its entirety. Alternatively, the support surface 21 borders at least one portion of the watering trough 3.

According to another embodiment, the support 2 is configured so as to have several support portions around the watering trough 3.

Alternatively, the support 2 comprises at least two support surfaces 21 (which actually forms a more complex general support surface) distributed around the watering trough 3. Advantageously, this enlarges the access surface to the watering trough 3.

Preferably and according to the same embodiment, the two support surfaces 21 are adjacent, and for example at 90° to each other so as to extend over two edges of the trough 3, and advantageously enable the simultaneous access to the watering trough by several animals at the same time. Preferably, this allows keeping one single internal cavity 22 while expanding the receiving capacity of the watering device 1.

According to one embodiment, the second portion 2b comprises a set of support surfaces 21.

According to a preferred embodiment of the invention, the support 2 is configured so as to be able to cover the lower face 20. Advantageously, this allows for a hermetic closure of the internal cavity 22 in which, for example, heat exchanges could occur.

Preferably, the watering trough 3 is polygonal and at least two support surfaces 21 extend from at least two adjacent sides of the watering trough 3.

Advantageously, the watering device 1 comprises lateral protection elements configured so as to encourage the animal to climb on at least one support surface 21. For example, this allows preventing the animal from coming to quench its thirst in the watering trough 3 from sides of the support 2 that do not have a support surface 21.

According to another embodiment, the watering device 1 comprises at least one ventilation element. Advantageously, this allows lowering the temperature within the internal cavity 22.

Advantageously, this also allows homogenising the heat exchanges within the internal cavity 22.

Preferably, the ventilation element is advantageously located in the internal cavity 22, preferably in the second portion 2b.

Advantageously, the ventilation element draws in the colder air from the outside, in particular from below the watering device 1, before expelling it in the direction of a radiator element in the internal cavity 22. This preferably allows making the heat present within the internal cavity 22. The air flow could be directed towards the hot portion of the Peltier device: towards the corresponding contact and/or a dissipating element such as a radiator placed in thermal conduction with the hot contact of the Peltier module.

Quite advantageously, the ventilation element is a parallelepiped-shaped fan with blades, oriented horizontally and configured so as to generate a vertical air flow. For example, this allows making the watering device 1 more compact.

According to one embodiment, the watering device 1 comprises a filter element configured so as to protect a ventilation element. Advantageously, the filter element enables the passage of air between the outside of the watering device and the ventilation element while preventing the passage of insects or dust.

The present invention also describes a method for cooling the liquid intended to be contained in the watering trough 3 of said watering device 1. As mentioned before, the cooling system 4 comprises a thermoelectric module 41. The thermoelectric module 41 is powered with mains current or by another means, such as an on-board battery. Possibly, a solar energy collector may be implemented, for example on the support surface, which is preferably quite large. The calories of the liquid contained in the watering trough 3 are evacuated from said watering trough 3 by successively establishing contact at least with the following elements: liquid, first contact element 410a, second contact element 410b, calorie receiver element 5.

We will now describe a second embodiment of the invention as represented in FIGS. 2A, 2B, and 2C. The second embodiment has features common to the first embodiment. Only the features differing from the first embodiment will be described hereinafter. In addition, the first embodiment and the second embodiment as well as any other embodiments as described by the invention could be combined.

According to a second embodiment and as represented in FIGS. 2A, 2B and 2C, the support 2 of the watering device 1 comprises an additional trough 23. The receiver element 5 is then contained within the additional tray 23 as illustrated in FIG. 2C. In this manner, the heat exchange is enabled between the liquid contained within the watering trough 3 and the receiver element 5 contained within the additional trough 23. The additional trough 23 has a bottom wall.

Advantageously, the additional trough 23 is removable from the watering device 1, preferably removable from the support 2. This facilitates filling of the additional trough 23 by the receiver element 5. This also allows facilitating cleaning of the additional trough 23. Advantageously, the receiver element 5 is a liquid such as water or air.

Quite advantageously, the first contact element 410a and the second contact element 410b of the thermoelectric module 41 respectively comprise a first heat-conductive plate 411a and a second heat-conductive plate 411b. The first heat-conductive plate 411a is immersed in the watering trough 3 so as to be in contact with the liquid to be cooled, whereas the second heat-conductive plate 411b is immersed in the additional trough 23 so as to be in contact with the receiver element 5 to be heated.

According to a non-limiting example, the first heat-conductive plate 411a has a length substantially equal to the length of the watering trough 3.

Thus, the heat exchanges between the liquid and the first heat-conductive plate 411b are maximised. The heat transfer of the calories contained within the liquid from the liquid towards the additional trough 23 then occurs more quickly. Consequently, cooling of the liquid occurs more quickly.

Preferably, a first passage orifice and a second passage orifice are provided in the support 2, preferably respectively in the first portion 2a of the support 2 and in the second portion 2b of the support 2. This enables the first heat-conductive plate 411a and the second heat-conductive plate 411b to be inserted respectively into the watering trough 3 and into the additional trough 23 respectively through the first passage orifice and the second passage orifice. To this end, the first heat-conductive plate 411a is immersed in the liquid contained within the watering trough 3, the second heat-conductive plate 411b is in contact with the receiver element 5 so as to enable a heat exchange between liquid and receiver element 5. According to an alternative example, a first plurality of passage orifices and a second plurality of passage orifices are provided respectively in the first portion 2a of the support 2 and in the second portion 2b of the support 2. To this end, a first plurality of heat-conductive plates 411a and a second plurality of heat-conductive plates 411b are inserted respectively into the watering trough 3 and into the additional trough 23 respectively through the first plurality of passage orifices and the second plurality of passage orifices. This allows increasing the heat-exchange surfaces and consequently reducing the time required for cooling of the liquid contained within the watering trough 3.

According to an advantageous embodiment, the first passage orifice and the second passage orifice are configured such that the first heat-conductive plate 411a and the second heat-conductive plate 411b are disposed respectively proximate to the bottom wall of the watering trough 3 and to the bottom wall of the additional trough 23.

Preferably, the first heat-conductive plate and the second heat-conductive plate are not in contact with, respectively, the bottom wall of the watering trough 3 and the bottom wall of the additional trough 23. This allows preventing thermal bridges between the first heat-conductive plate 411a and the bottom wall of the watering trough 3.

According to an alternative example, the first heat-conductive plate 411a is configured so as to be in contact with the outer surface of the watering trough 3, preferably with the outer surface of the bottom wall of the watering trough 3. Thus, the heat transfer occurs from the liquid towards the first heat-conductive plate 411a through the bottom wall of the watering trough 3. Similarly, the second heat-conductive plate 411b may be configured so as to be in contact with the outer surface of the additional trough 23, preferably with the outer surface of the bottom wall of the additional trough 23.

As a non-limiting example, the device as described by the invention has, through the aforementioned features, a temperature difference of the liquid comprised between 3 and 4° C. which could be reached in 1 hour, preferably comprised between 8 and 12° C. which could be reached in 6 hours, for 1 liter of drinking water at room temperature cooled by a 150 Watt Peltier module.

The invention is primarily intended to be used by cats but could also be used by other animals, such as small dogs, ferrets, horses, etc.

The invention is not limited to the previously-described embodiments and extends to all of the embodiments covered by the claims.

### LIST OF REFERENCES

1 Watering device
2 Support
2a First portion
2b Second portion
20 Lower face
21 Support surface
22 Internal cavity
220 Ventilation channels
23 Additional trough
3 Watering trough
30 Upper border
4 Cooling system
41 Thermoelectric module
410a First contact element
410b Second contact element
410b′ Dissipation fins
411a First hear-conductive plate
411b Second heat-conductive plate
5 Receiver element
L Length of the support
P Depth of the support surface
H Height of the watering trough/support surface

1. A watering device for animals, the device comprising a support, which comprises:
a. a watering trough intended to receive a liquid,
b. a system for cooling the liquid,
wherein:
i. the liquid cooling system comprises a thermoelectric module powered with a current and having a first contact element and a second contact element, the first contact element being configured to cool the liquid,
ii. the second contact element is in thermal conduction with a receiver element intended to receive calories,
iii. the support comprises a support surface bordering the watering trough, said support having a lower face intended to bear on the ground so that the support surface is parallel to the lower face, in that the support is partly hollow, defining an internal cavity of the support so that the receiver element is contained within the internal cavity of the support, the internal cavity of the support being located under the support surface.

2. The watering device according to claim 1, wherein the first contact element is in thermal conduction with the watering trough so as to enable a heat exchange between the first contact element and the watering trough.

3. The watering device according to claim 1, wherein the second contact element has dissipation fins configured to dissipate calories to the receiver element.

4. The watering device according to claim 1, wherein the support comprises a first portion carrying the watering trough and a second portion distinct from the first portion so that the thermal conduction resistance of the first portion is higher than the thermal conduction resistance of the second portion.

5. The watering device according to claim 1, wherein the support surface is flush with an upper edge of the watering trough.

6. The watering device according to claim 1, wherein the support surface has a depth P starting from the upper edge of the watering trough, said depth P being at least 4 cm.

7. The watering device according to claim 1, wherein the support surface is intended to receive the legs of the animal, said support surface extending at least at the same height H as the upper edge of the watering trough.

8. The watering device according to claim 1, wherein the internal cavity of the support has ventilation channels forming a passage between the internal cavity of the support and the outside of the support.

9. The watering device according to claim 1, wherein the support comprises an additional trough, containing the receiver element so as to enable a heat-exchange between the liquid contained within the watering trough and the receiver element contained within the additional trough.

10. The watering device according to claim 1, wherein the first contact element and the second contact element of the thermoelectric module respectively comprise a first heat-conductive plate and a second heat-conductive plate.

11. The watering device according to claim 1, wherein the first plate is immersed in the watering trough.

12. The watering device according to claim 1, wherein the first heat-conductive plate has a length substantially equal to the length of the watering trough.

13. The watering device according to claim 1, wherein the watering trough is removable from the support.

14. The watering device according to claim 1, wherein the watering trough is made of a material whose thermal conductivity is higher than 10 Watts per metre-Kelvin at 20° C.
